(19) United States
(12) Patent Application Publication
(10) Pub. No.: US 2002/0099627 A1
(43) Pub. Date: Jul. 25, 2002

(54) Gateway service system, device service system, data management server, and home gateway system

(75) Inventors: Toshiaki Igi, Fujisawa-shi (JP); Hiroshi Ishikawa, Shizuoka-shi (JP); Shinichiro Yamada, Kawasaki-shi (JP); Shunichi Mukai, Fujisawa-shi (JP)

Correspondence Address: Jerry W. Herndon, IBM Corporation T81/062, PO Box 12195, Research Triangle Park, NC, 27709, US

(73) Assignee: International Business Machines Corporation, Armonk, NY

(21) Appl. No.: 10/037,760

(22) Filed: Oct. 23, 2001

(30) Foreign Application Priority Data
Oct. 23, 2000 (JP) 2000-322595

(51) Int. Cl. G06F 17/60

(52) U.S. Cl. 705/27

(57) ABSTRACT

Gateway service provider 20 acquires and stores personal data of user 10 and device data of devices owned by user 10 when home gateway 11 is registered. Then, gateway service provider 20 sends such information or services based on the information to customer company 40A and in return receives payment from customer company 40A. As a result, customer company 40A can provide articles, contents and services to user 10.

### FIELD OF THE INVENTION

The present invention relates to a gateway service system and device service system which can be given services at home through the Internet.

### BACKGROUND ART

As is well known in the art, with the wide spread of the Internet, various devices such as televisions and telephones, in addition to personal computers (hereinafter referred to as “PC”), have been equipped with the Internet connect function even at home. However, whenever a user newly purchases a device equipped with the Internet connect function, the user has to set up a connection to an access point to connect the device to the Internet, which may take time. Furthermore, these devices need wiring for a communication line in the home, which may also take time. Besides, as the number of devices increases, the wiring becomes more complicated.

To solve these problems, an apparatus called home gateway is attracting attention these days. One home gateway is installed in a home, to which each device that is capable of using the Internet is connected. The home gateway is connected to the Internet via the public telephone line network. By setting up a connection to the Internet in the home gateway, each device connected to the home gateway can utilize the Internet without respectively setting up the Internet connection. In this way, by installing the home gateway, a user can save trouble in setting up the Internet connection and can put the wiring together in the home, resulting in great convenience for the user. As a result, it is expected that those devices capable of accessing the Internet will prevail much more.

However, as a matter of course, the installation of a home gateway requires a user to bear the purchase expense and other costs involved in the installation. Furthermore, in the conventional home gateway, even a feeder for receiving television broadcast signals, for example, has to be connected to the home gateway together with other lines when a television set is to be connected to the home gateway. Thus, under the present conditions, there are some problems to be solved for the home gateway to be widely used in every home.

In another aspect, with the wide spread of the Internet, various kinds of electronic commerce have been proposed and transactions are actually being conducted in which users can conveniently acquire articles without going all the way to shops or without getting catalogs, whereas the fact is that the electronic commerce has been utilized only by users having a PC. However, as devices other than personal computers, such as televisions or telephones, become capable of utilizing the Internet and the spread of such devices will be more accelerated by means of home gateways, it is expected that the electronic commerce will become popular among a much wider class of users than before.

Conventional electronic commerce has been practically limited to a passive form of transactions, in which providers (sellers) of articles, services, etc. (hereinafter called articles collectively), such as companies and shops, opened their home pages on the Internet, present the articles to be provided to users on the home pages, and wait for a user or users to purchase the articles. Hence, if the providers desire to increase sales, it is necessary to put advertisements on the Internet or advertising media such as newspapers, magazines, and televisions to urge users to access their home pages. However, these advertisements are not necessarily efficient in terms of costs since they are aimed at not only prospective users but also many and unspecified users.

On the other hand, for a user who utilizes electronic commerce, when the user purchases an article presented by a provider on their home pages, it is necessary to inform the provider of the user's personal data such as address, name, telephone number, and credit card number or bank account number for payment. As is well known in the art, such personal data might be stolen or intercepted on the Internet, or the provider might leak or abuse the personal data. For this reason, many users are serious about communicating personal data over the Internet, which is regarded as a factor in preventing further spread of electronic commerce, despite the fact that countermeasures have been devised using encryption techniques.

As described above, the current electronic commerce has problems both on the provider's side and user's side, which must be solved to further spread the Internet by introducing the home gateway.

### SUMMARY OF THE INVENTION

The present invention is proposed in view of such problems, and its object is to provide a gateway service system, a device service system, a data management server, and a home gateway system capable of enhancing the convenience on the user's side.

In view of the above object, a gateway service system of the present invention is characterized in that a home gateway, which manages devices owned by a user, transmits personal data of the user to a server of a service provider, and the server of the service provider stores the received personal data of the user. Furthermore, the server of the service provider may store device data of the devices owned by the user by associating with the personal data.

In such a gateway service system, the service provider is capable of providing services to users and third parties utilizing the stored personal data and device data. For example, the service provider extracts and provides for a third party a portion of the stored personal data. The extracted data may be that of a user satisfying a condition specified by a third party, which is then provided to the third party. Also, the service provider may provide personal data for the third party that the provider spontaneously extracted. Moreover, based on a request of a third party, the service provider may extract users who satisfy a condition specified by the third party and deliver or dispatch to the extracted users information supplied from the third party, such as advertisements, guides or the like. The third party may be any entity or company which provides (or sells) articles, contents and/or services.

In this gateway service system, an object to be provided from a third party, such as an article, may be ordered via the server of the service provider. In that case, the server of the service provider generates communicative order data excluding personal data that identifies a user (e.g., address, name, credit card number, etc.), and transmits the data to the third party. Because of this, the third party cannot identify the user who ordered, whereby anonymity of the user is assured against the third party.

Responsive to the communicative order data, the third party delivers the object to the service provider, which then dispatchs the object to the user based on the stored personal data of the user, whereby anonymity of the user is assured against the third party upon dispatching.

In addition, the user may pay the third party via the service provider for the object provided from the third party, whereby anonymity of the user is also assured against the third party at the time of payment.

This gateway service system may also be characterized in that the service provider charges a third party for the personal data or any other service provided to the third party. Receiving money from the third party, the service provider will be able to provide a home gateway for a user at a low price.

The present invention may be seen as a device service system characterized in that a server of an administrator acquires device data of electric devices capable of accessing an external network such as the Internet from a home system, extracts device data satisfying a condition specified by a third party from the acquired device data, and transfers the extracted device data to a server owned by a service implementor. Thus, the service implementor, which may be a manufacturer, seller, or service company for electric devices, can implement services with respect to the electric devices owned by a user. Services implemented may include maintenance of an electric device, providing information about this electric device, and introduction of new products related to this electric device. In this system, the service implementor may commission the administrator to search for users who own a specific electric device. The administrator may then extract device data corresponding to that specific electric device from the acquired device data, identify corresponding users, and notify them to the service implementor.

For a user having electric devices in the home system capable of accessing an external network such as the Internet, even if these devices are manufactured by different manufacturers, the user can contact each manufacturer via the administrator, thereby advantageously saving time and trouble.

Such a home system may be configured such that each of the electric devices directly accesses the external network, or the system may include a home gateway capable of accessing the external network and each device is connected to the home gateway.

The data management server of the present invention accepts a registration of personal data from a user who owns a home gateway to which a plurality of Internet devices can be connected, and stores the personal data. The server may also accept device data of the Internet devices owned by the user and store the device data by associating it with the personal data. Then, the server may extract a user satisfying an externally specified condition based on the stored personal data. In addition, the server may externally output the personal data of the extracted user after excluding at least data that identifies this user.

The home gateway system of the present invention includes a home gateway that can be connected to an external network, and to one or more devices via an internal network, and manages these devices, wherein personal data of a user who owns the home gateway and device data of the devices are registered in a server of an external administrator.

If data communication between the home gateway and the devices is established by a radio communication such as Bluetooth, there is no need of wiring between the home gateway and the devices. Furthermore, the home gateway may be only responsible for connecting the devices to the network. More specifically, with respect to a device such as a television, an antenna wire for receiving electric waves may be directly connected to the television as before not through the home gateway.

In this manner, a user having such a home gateway system can utilize the services based on the personal data and device data stored in the server of the external administrator, whereby convenience will be enhanced for the user.

### BRIEF DESCRIPTION OF THE DRAWINGS

FIG. 1 is a diagram illustrating a configuration of the gateway service system according to the present invention.

FIG. 2 is a diagram illustrating a configuration of the home system.

FIG. 3 is a flowchart showing registration of the home gateway.

FIG. 4 depicts an example of one form of providing services in the gateway service system according to the present invention.

FIG. 5 depicts an example of another form of providing services.

FIG. 6 depicts an example when ordering articles or the like.

FIG. 7 depicts an example for payment.

FIG. 8 depicts an example when receiving maintenance services.

### PREFERRED EMBODIMENTS OF THE INVENTION

The present invention is described with reference to the accompanying drawings.

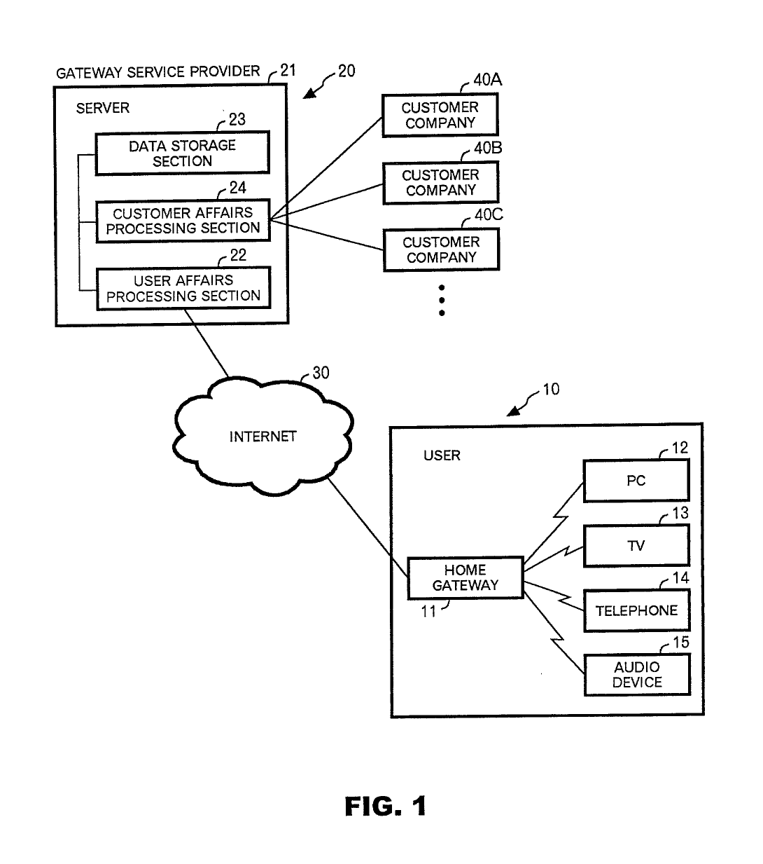

FIG. 1 is a diagram illustrating a configuration of the gateway service system (device service system) according to the present invention. As shown in this drawing, the gateway service system is basically composed of a user 10 and a gateway service provider (administrator) 20 with whom the user 10 makes a contract (registration).

The user 10 owns a home system (home gateway system), which includes a home gateway 11 provided by the gateway service provider 20 and various kinds of apparatuses or electric devices connected to the home gateway 11, including a PC 12, television (TV) 13, telephone 14, audio device 15, etc.

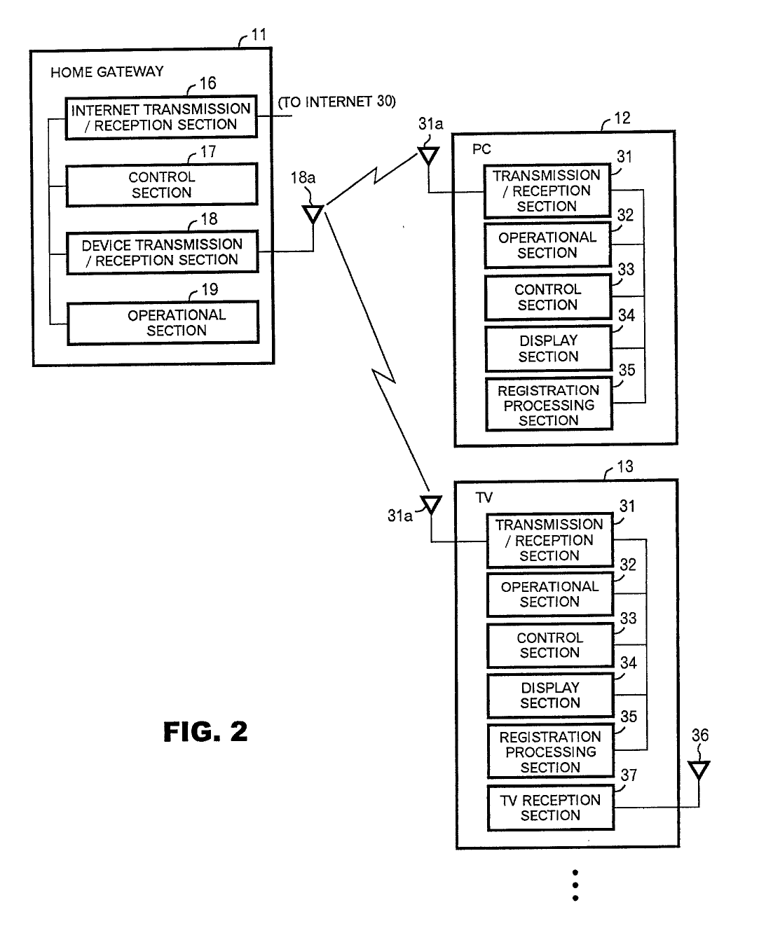

As shown in FIG. 2, the home gateway 11 includes an Internet transmission/reception section 16, a control section 17, a device transmission/reception section 18, and an operational section 19. The Internet transmission/reception section 16 is connectable to the Internet (network or external network) 30 after setting an access point and the like in the home gateway 11 in advance. The control section 17 manipulates data sent or received at the Internet transmission/reception section 16 and the device transmission/reception section 18. The device transmission/reception section 18 sends and receives data to and from each device, and composes an internal network using wireless data communication such as Bluetooth, for example. For this purpose, the device transmission/reception section 18 is equipped with an antenna 18a for short-range communication. The operational section 19 is used for user operations such as registration of the home gateway 11 with the gateway service provider 20 and setting up for connection to the Internet 30.

On the other hand, each of the devices connectable to the home gateway 11, that is, PC 12, television (TV) 13, telephone 14, audio device 15, etc. (for convenience, only PC 12 and television 13 are shown in FIG. 2), includes at least a transmission/reception section 31, an operational section 32, a control section 33, a display section 34, and a registration processing section 35.

The transmission/reception section 31 is equipped with an antenna 31a to perform data communication with the device transmission/reception section 18 of the home gateway 11 within the internal network using wireless communication such as Bluetooth. The operational section 32 is used to perform operations for sending and receiving data over the Internet with an input device such as a mouse, buttons, or a keyboard. The control section 33 performs processing based on the operations at the operational section 32 and processing based on data received externally over the Internet 30, and the display section 34 displays characters and images depending on such processing.

The registration processing section 35 is used by a user to register a device in the gateway service provider 20 via the home gateway 11 when the user purchases the device such as television 13. The television 13 is equipped with a TV reception section 37 having an antenna 36 for receiving electric waves of television broadcasts. This antenna 36 is directly connected to the television 13 in a conventional way without interposing the home gateway 11 therebetween.

As shown in FIG. 1, the gateway service provider 20 not only sends and receives data to and from the user 10 over the Internet 30, but also affiliates with customer companies (third parties, service implementors, etc.) 40A, 40B, 40C, . . . , and provides services related to the user 10 registered with the gateway service provider 20. The customer companies 40A, 40B, 40C may be various entities, including sellers/manufacturers/distributors providing various kinds of goods (articles), banks/insurance companies providing various kinds of services, and contents sellers selling music and video contents. Of course, those which affiliate with the gateway service provider 20 are not limited to companies, but may be individuals who make a certain contract with the gateway service provider 20.

Such a gateway service provider 20 owns a server (data management server) 21 connectable to the Internet 30. The server 21 comprises a user affairs processing section (registration processing section) 22 that performs various kinds of processing for the user 10 via the Internet 30, a data storage section 23 for storing data acquired from the user 10, and a customer affairs processing section (extraction processing section) 24 for performing processing for the customer companies 40A, 40B, 40C based on data stored in the data storage section 23. In the present embodiment, the customer affairs processing section 24 exchanges data with the customer companies 40A, 40B, 40C, more specifically with servers owned by them (not shown) via the Internet 30 or other networks or dedicated lines.

Next, the operations of such a gateway service system will be described.

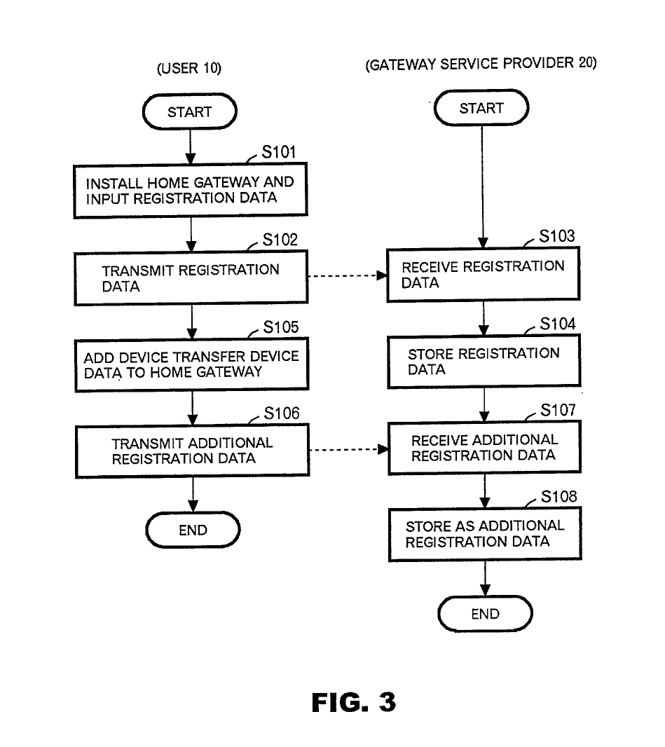

First, with reference to FIG. 3, a flow of registration in the gateway service provider 20 on the user 10 side will be described. In step S101 in FIG. 3, the user 10 installs the home gateway 11 acquired from the gateway service provider 20. This is preferably performed such that a worker dispatched from the gateway service provider 20 fixedly installs the home gateway 11 at a specific place in a home, making it difficult for the user 10 to move it by him/herself.

Then, a connection to an access point is set up at the operational section 19 of the home gateway 11 to access the Internet 30. Becoming connectable to the Internet 30, the user 10 accesses to the server 21 of the gateway service provider 20 via the Internet 30. Then, the user 10 registers with the gateway service provider 20 by inputting his/her own registration data from the operational section 19 of the home gateway 11. The registration data which should be input at this moment includes identification data of the user 10 such as an address, name, telephone number, and mail address; settlement data such as a credit card number and a bank account number to make payments to the gateway service provider 20; and an ID number of the home gateway 11. Since these data should prove the identity of the user 10, the gateway service provider 20 carries out examinations and credit inquiries about these data as needed. Furthermore, other additional data may be input depending on the choice of the user 10, including hobbies, family, financial institutes with which the user 10 has dealings, and type and expiration date of insurance contracts. The user 10 determines whether to input such additional data or not at his or her own discretion since, by inputting the additional data, the user 10 may receive services and information from the gateway service provider 20 (or customer companies 40A, 40B, 40C) depending on the input data.

After the user 10 inputs the registration data in the home gateway 11 as described above, the user 10 performs transmission operations for those data at the operational section 19. As a result, the input data are transmitted by the control section 17 from the Internet transmission/reception section 16 (step S102).

The transmitted registration data are received by the server 21 of the gateway service provider 20 via the Internet 30. In the server 21, the user affairs processing section 22 receives the registration data (step S103). Then, the user affairs processing section 22 stores the received registration data in the data storage section 23. In the data storage section 23, the aforementioned personal data including identification data, settlement data, ID number and additional data are stored, in association with a registration number given to identify the user 10 (step S104).

Described above is an example of online registration utilizing the home gateway 11. However, it may be difficult to confirm the identity of the user 10 using only the data input by the user 10. Therefore, it is preferable to request the user 10 to submit a certificate of residence or to exhibit an identification card (driver's license, etc.). For example, when the gateway service provider 20 makes a contract with the user 10 for installation of the home gateway 11, such an identity check may be conducted. At that time, if the user 10 provides data like those which are input at the time of online registration described above, the registration of personal data would be completed at the time of making the contract. The personal data may be registered in association with a unique number of the home gateway 11 (e.g., device or serial number) instead of information that identifies the user 10.

At the same time as the registration of the home gateway 11 or at an appropriate time after the registration, the user 10 registers devices such as PC 12, television 13, telephone 14 and audio device 15, according to the following procedure (hereinafter, the television 13 will be taken as an example). First, to prevent dishonest registration, it is preferable to input a predetermined password, specified by the gateway service provider 20, to the home gateway 11.

Then, the user 10 performs predetermined operations for registration at the operational section 32 of the television 13. In response to the operations at the operational section 32, the registration processing section 35 causes the transmission/reception section 31 to transfer device data to the home gateway 11, including a manufacturer, model name, type, and serial number of the television 13. The home gateway 11 receives the device data at the device transmission/reception section 18 and stores them in a memory as needed (step S105).

Alternatively, in step S105, the registration processing section 35 of the television 13 does not perform the registration processing automatically, but the user 10 may input device data of the television 13 to the home gateway 11 directly. In that case, the home gateway 11 needs to be equipped with input means such as a keyboard to input the device data. Since, in step S105, wireless data communication such as Bluetooth is used to transfer the device data from the registration processing section 35 of the television 13 to the home gateway 11, there is a likelihood that the device data be intercepted or transferred to a different home gateway nearby. On the contrary, if the user 10 inputs the device data directly to the home gateway 11, the device data could be definitely registered in the proper home gateway 11.

Thereafter, the home gateway 11 transmits from the Internet transmission/reception section 16 the device data as additional registration data, which are received automatically or as a result of predetermined operations by the user 10 (step S106).

The server 21 of the gateway service provider 20 receives the device data (additional registration data) via the Internet 30 (step S107). The user affairs processing section 22 additionally stores the received device data in the data storage section 23, in association with the personal data (registration data) of the user 10 already stored (step S108).

The device data registration in the gateway service provider 20 may be performed in parallel with the registration processing of the home gateway 11 in steps S101 through S104. In that case, a series of operations in steps S105 through S108 may be included in steps S101 through S104.

In this registration processing, not only addition but also deletion of device data may be performed for a device which has been registered in the gateway service provider 20 but no more needed by the user 10. In the deletion, it is also effective to input a password to the home gateway 11 at the start of the deletion processing or to perform input operations directly at the home gateway 11 without using the wireless data communication in order to prevent dishonest processing.

In this manner, the personal data of the user 10 including identification data, settlement data, ID number, and additional data, and the device data about the home gateway 11 and various devices connected therewith are stored in the data storage section 23 at the gateway service provider 20.

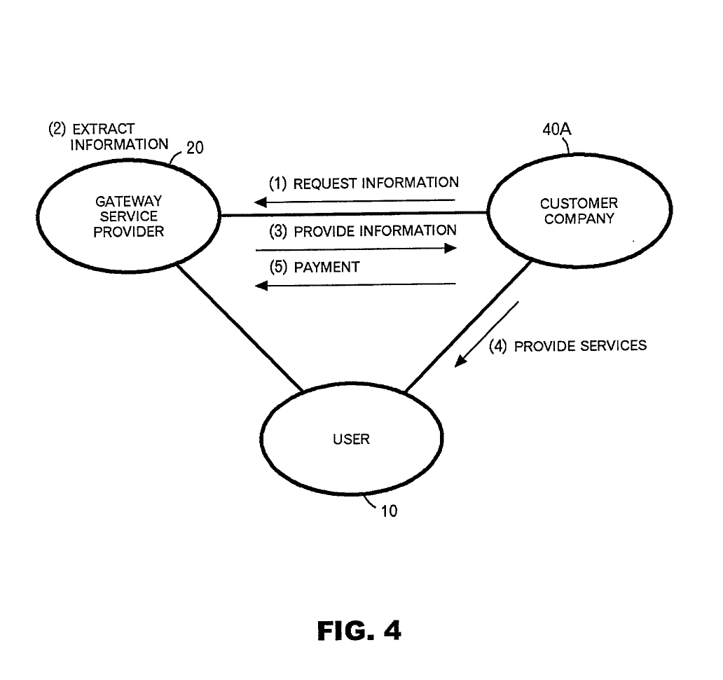

Next, with reference to FIG. 4, there will be described an example of a form of providing services to the user 10 by the gateway service provider 20 which has accepted the registration data from the user 10. While only one user 10 is shown in FIG. 4 and succeeding drawings, there may be a plurality of users 10 who should receive services.

In an example shown in FIG. 4, a customer company 40A requests the gateway service provider 20 to provide information about the user (or users as described above) 10 who satisfies a specified condition among all users registered in the gateway service provider 20, as shown by message flow (1). More specifically, assuming that the customer company 40A is a manufacturer of televisions, it may request information about the user 10 who owns an old model television 13 when it brings out a new model of the television 13. Alternatively, if the customer company 40A is an insurance company, it may request information about the user 10 who has carried insurance (preferably of a different company) which will mature in a few days (a period of time should be specified).

As shown by (2) in FIG. 4, responsive to this request, the gateway service provider 20 causes the customer affairs processing section 24 (see FIG. 1) to search the data storage section 23 and to extract the user 10 who satisfies the specified condition among all users. In the example described above, extracted are those who registered the type of old model television 13 as the device data or who input an expiration date of insurance as additional data which falls within the specified period. In that case, any user 10 who did not input the expiration date of insurance as additional data is not extracted.

Then, as shown by (3) in FIG. 4, the gateway service provider 20 transmits information about the extracted user 10 to a server (not shown) of the customer company 40A. At this time, for the purpose of protection of personal data of the user 10, it is preferable to provide only required minimum information including an address, name, mail address, etc. rather than all the personal data.

As shown by (4) in FIG. 4, responsive to the received information, the customer company 40A provides services such as advertisements to the extracted user 10 according to the address, name, and mail address provided. Then, as shown by (5) in FIG. 4, the customer company 40A pays the gateway service provider 20 for the information given by the gateway service provider 20.

In such a service providing form, upon advertising, the customer company 40A can narrow down objects of advertisement based on the user 10 data stored at the gateway service provider 20, thereby working out an efficient advertising strategy. On the other hand, the user 10 can receive information conforming to his/her own devices or insurance contracted, thereby acquiring useful information and services.

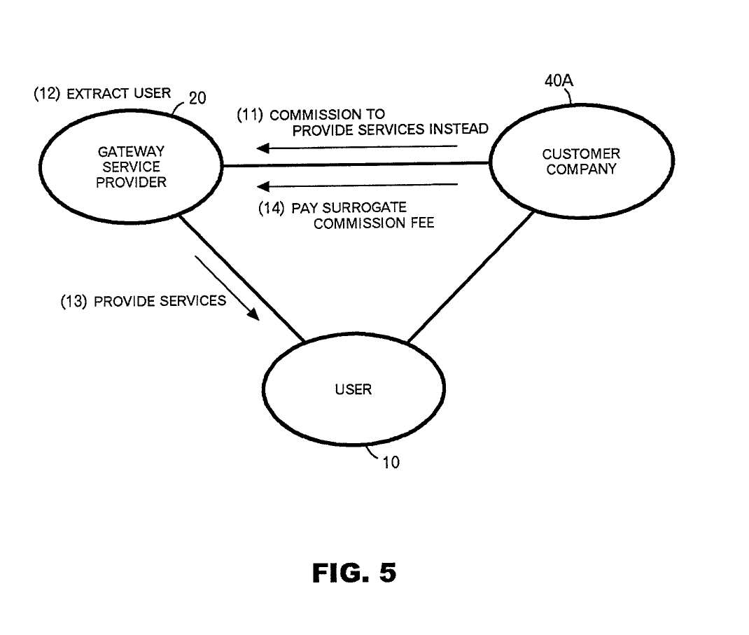

Next, with reference to FIG. 5, there will be described another example of the form of providing services to the user 10 by the gateway service provider 20.

In an example shown in FIG. 5, as shown by (11), the customer company 40A commissions the gateway service provider 20 to act for the company itself to provide services to the user 10 who satisfies a specified condition among all users registered in the gateway service provider 20. More specifically, assuming that the customer company 40A is a manufacturer of televisions, when it brings out a new model of television 13, it commissions the gateway service provider 20 to deliver or distribute advertisements to the user 10 who owns an old model television 13. Alternatively, if the customer company 40A is an insurance company, it commissions the gateway service provider 20 to deliver or distribute a guide or the like to the user 10 who carries insurance which will mature in a specified period of time. In that case, the gateway service provider 20 receives data of services to be provided such as advertisements and guides from the customer company 40A together with the commission or request.

As shown by (12) in FIG. 5, responsive to this request, the gateway service provider 20 causes the customer affairs processing section 24 (see FIG. 1) to search the data storage section 23 and to extract the user 10 who satisfies a specified condition among all users.

Then, as shown by (13) in FIG. 5, the gateway service provider 20 provides (dispatches) services such as advertisements and guides received from the customer company 40A to the extracted user 10 using a registered address, name, mail address, etc. At that time, if the advertisements and guides received from the customer company 40A are in the form of data, these are delivered over the Internet, while if these are in the form of articles, they are dispatched.

Then, as shown by (14) in FIG. 5, the gateway service provider 20 receives payment (surrogate commission fee) from the customer company 40A for its agent business of providing services to the extracted user 10.

In such a service providing form, upon advertising, the customer company 40A can narrow down objects of advertisement, thereby working out an efficient advertising strategy, like the aforementioned form of providing services (Case 1). On the other hand, the user 10 can receive useful information and services. Moreover, since there is no concern that the customer company 40A knows data of the user 10, this form is preferable to the user 10 from the viewpoint of personal data protection.

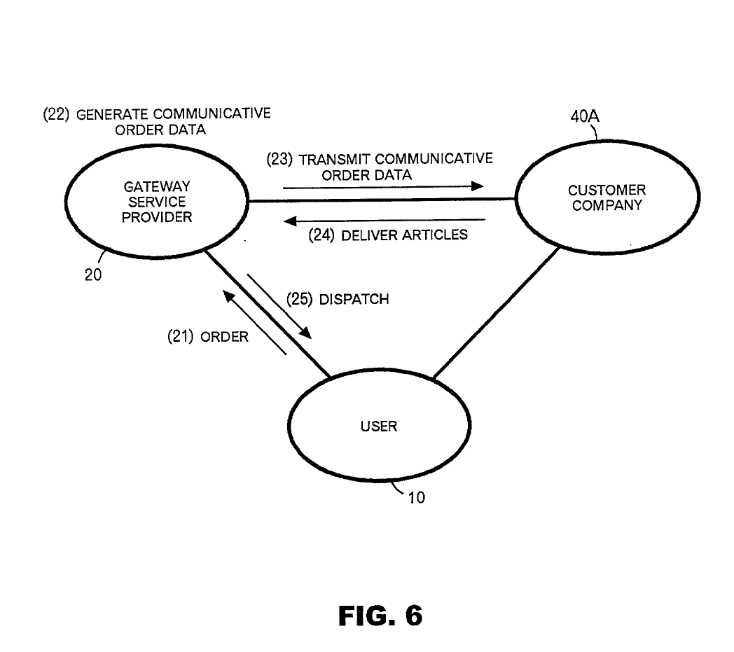

When the user 10 orders articles, contents and/or services that are provided by the customer companies 40A, 40B, 40C, the user 10 may order via the gateway service provider 20 as shown by (21) in FIG. 6, while the user may otherwise order directly to the customer company 40A, for example. In the former case, the user 10 sends a name and number of articles or services he/she orders as the order data for indicating the ordered contents, as well as a registration number that is used by the gateway service provider 20 to identify the user 10, from the home gateway 11 or a device such as television 13 connected to the home gateway 11.

In that case, as shown by (22) in FIG. 6, the server 21 of the gateway service provider 20 generates communicative order data that communicates the ordered contents to the customer company 40A based on the received order data. The communicative order data are generated by excluding identification data of the user 10 such as an address, name, telephone number, etc., in order to prevent the customer company 40A from identifying the user 10, thereby only including the name and number of articles, for example. Then, as shown by (23) in FIG. 6, the server 21 of the gateway service provider 20 sends the generated communicative order data to a server (not shown) of the customer company 40A. At this point in time, the order from the user 10 reaches the customer company 40A via the gateway service provider 20.

Then, as shown by (24) in FIG. 6, the customer company 40A delivers the articles conforming to the communicative order data, i.e., the article ordered by the user 10, to the gateway service provider 20. Thereafter, as shown by (25) in FIG. 6, the gateway service provider 20 dispatches the received articles to the user 10 according to the address and name derived from the registration number contained in the order data.

In this manner, the gateway service provider 20 conducts an agency or surrogate business of dispatching articles or the like, while the user 10 can order articles without having personal data known to the customer company 40A.

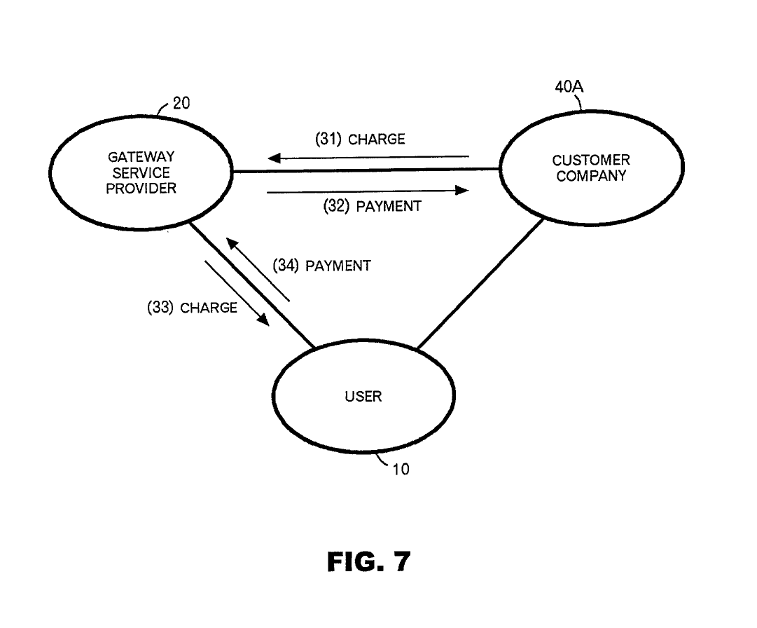

In the aforementioned two forms of providing services, when charging for the services provided to the user 10, or when the user 10 pays for the articles that he/she purchased, the user 10 may pay for them via the gateway service provider 20, as shown in FIG. 7. Namely, as shown by (31) in FIG. 7, the customer company 40A charges the gateway service provider 20 for services and articles provided to the user 10. As shown by (32) in FIG. 7, the gateway service provider 20 pays the customer company 40A for the charged things at an appropriate time. On the other hand, as shown by (33) in FIG. 7, the gateway service provider 20 charges the user 10 via the Internet 30 and the home gateway 11, and receives payment from the user 10 as shown by (34) in FIG. 7. The payment may be made by a credit card or by direct debit from a specified account based on the settlement data that the user 10 registered. Thus, the user 10 has never his settlement data known to the customer company 40A, whereby personal data is definitely protected.

Note that the payment from the gateway service provider 20 to the customer company 40A shown by (32) in FIG. 7 and the payment from the user 10 to the gateway service provider 20 shown by (34) in FIG. 7 may be in any order.

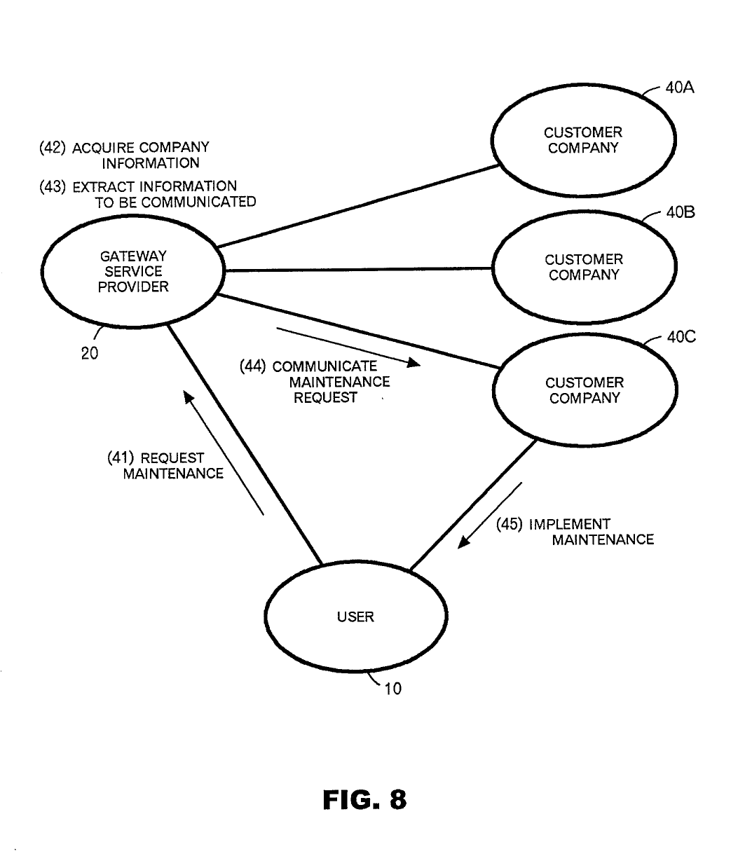

According to the gateway service system of the present invention, maintenance of devices owned by the user 10, for example, television 13, may be provided via the gateway service provider 20. Namely, as shown by (41) in FIG. 8, when the television 13 owned by the user 10 has a trouble, the user 10 requests maintenance to the gateway service provider 20 via the home gateway 11. As shown by (42) in FIG. 8, responsive to the request from the user 10, the gateway service provider 20 acquires a name of a manufacturer (company information, for example, customer company 40C) of the television 13 owned by the user 10 based on the data stored in the data storage section 23. Furthermore, as shown by (43) in FIG. 8, the device data of the television 13 owned by the user 10 such as a type and serial number, and identification data of the user 10 such as address, name and telephone number are extracted as data to be communicated. Then, as shown by (44) in FIG. 8, the gateway service provider 20 communicates the maintenance request to the customer company 40C as well as the device and identification data of the user 10. As shown by (45) in FIG. 8, responsive to these data, the customer company 40C implements maintenance of the television 13 for the user 10 based on the communicated device identification data.

In this manner, when the user 10 encounters a trouble with a device he/she owns such as television 13, the user 10 can save time for examining and contacting with a contact address. In particular, when the user 10 owns a lot of devices, their management becomes easy.

According to the aforementioned gateway service system, the gateway service provider 20 can receive payment from the customer companies 40A, 40B, 40C by managing the registration data about the user 10 who owns the home gateway 11 and providing the registration data or services based thereon to the customer companies 40A, 40B, 40C. Thus, the gateway service provider 20 can provide the home gateway 11 to the user 10 at a low cost or for free. As a result, the user 10 can save the cost of installation of the home gateway 11.

In the home system of the user 10, since the data communication between the home gateway 11 and the devices such as PC 12, television 13, etc., is implemented by wireless communication such as Bluetooth, wiring in a home is unnecessary so that the user 10 can save time and trouble, and further the installation place for each device would not be restricted and complicated wiring is not required. Moreover, by registering the device data of PC 12, television 13, etc. at the gateway service provider 20, the user 10 can appropriately receive maintenance services and various kinds of information. In this manner, various problems are solved with respect to the installation of the home gateway 11 so that the home gateway 11 is expected to become widely used.

In addition, the gateway service provider 20 stores the registration data of the user 10 who owns the home gateway 11. Based on the stored registration data, the gateway service provider 20 can provide such data or services based on the data to the customer companies 40A, 40B, 40C, etc. Thus, upon advertising, the customer companies 40A, 40B, 40C can narrow down objects of advertisements, thereby working out efficient advertising activities especially in terms of costs.

Furthermore, since the gateway service provider 20 confirms the identity of the user 10, installs the home gateway 11 in due course, and takes measures to prevent dishonest or erroneous registration of device data from occurring, the gateway service provider 20 can provide very reliable and value added data and services to the customer companies 40A, 40B, 40C.

For the user 10, the convenience is greatly improved because the user 10 can get information such as advertisements and purchases or receive articles or services based on the personal and device data that the user 10 has registered with the gateway service provider 20. In addition, the user 10 can maintain anonymity against the customer companies 40A, 40B, 40C through the intermediary of the gateway service provider 20, when receiving services from, ordering articles from, and paying to the customer companies 40A, 40B, 40C. Hence, the anxiety of the user 10 about conducting the electronic commerce is relieved.

In this manner, with the gateway service system that comprises the home gateway 11 and the server 21 of the gateway service provider 20, obstacles at the stage of further spreading not only the electronic commerce but also the Internet are removed.

While, in the above embodiments, actual devices owned by the user 10 are illustrated, other devices may also be used. Further, while the wireless communication such as Bluetooth is used between the home gateway 11 and each device such as television 13, this may be replaced with infrared communication or conventional wiring may be used. In such cases, the gateway service system can achieve the same effect as mentioned above as a whole.

While, in the above embodiments, the gateway service provider 20 receives from the customer company 40A the condition of the user 10 to be extracted and conducts agency business to provide information and services, the present invention may not be limited thereto, and the gateway service provider 20 may voluntarily extract and present data. Furthermore, while the above embodiments are all intended to sell or provide articles and services to the user 10, the gateway service provider 20 may conduct a marketing research, that is, the gateway service provider 20 may survey the number of users who satisfy the specified condition in response to the request from the customer companies 40A, 40B, 40C, and report it to the customer companies 40A, 40B, 40C.

In addition to above changes, the embodiments may be variously modified and changed without departing from the spirit and scope of the present invention.

We claim:

1. A gateway service system, comprising:
a home gateway for managing devices owned by a user; and
a server of a service provider communicable with the home gateway via a network,
wherein said home gateway transmits personal data of said user to said server of said service provider via said network, and said server of said service provider stores the personal data of said user received.

2. The gateway service system according to claim 1, wherein said home gateway transmits device data of devices owned by said user to said server of said service provider via said network, and said server of said service provider stores said device data received by associating with said personal data.

3. The gateway service system according to claim 1, wherein said server of said service provider extracts a portion of said personal data stored and provides said portion for a third party.

4. The gateway service system according to claim 3, said server of said service provider provides said third party with said personal data of said user that satisfies a condition specified by said third party.

5. The gateway service system according to claim 1, wherein said server of said service provider extracts said user who satisfies a condition specified by a third party based on said personal data stored and delivers information provided by said third party to said home gateway of said extracted user via said network.

6. The gateway service system according to claim 1, wherein said home gateway transmits order data for an object such as an article or contents provided by a third party to said server of said service provider via said network, and said server of said service provider generates communicative order data by excluding said personal data which identifies said user based on said order data received from said user, and communicates said communicative order data to said third party.

7. The gateway service system according to claim 6, wherein responsive to said communicative order data, said third party passes said object to said service provider, and said service provider dispatches said object to said user based on said personal data of said user stored in said server of said service provider.

8. The gateway service system according to claim 1, wherein said user orders from a third party an object such as an article, contents or service provided by said third party via said service provider, said service provider pays said third party for said object that said user ordered, and said user pays said service provider for said object.

9. The gateway service system according to claim 1, wherein said service provider charges a third party for personal data or services based on said personal data that said server of said service provider provides for said third party.

10. A device service system, comprising:
a home system for managing electric devices capable of accessing to an external network;
a server of an administrator connected to said home system via said external network; and
a server owned by a service implementor implementing services related to said electric devices,
wherein said server of said administrator acquires device data of said electric devices from said home system via said external network, extracts device data satisfying a specified condition from said acquired device data, and transfers said extracted device data to said server owned by said service implementor.

11. A data management server, comprising:
a registration processing section for accepting a registration of personal data of a user who owns a home gateway to which a plurality of Internet devices can be connected;
a data storage section for storing said personal data registered with said registration processing section; and
an extraction processing section for extracting a user who satisfies a specified condition, based on said personal data stored in said data storage section.

12. The data management server according to claim 11, wherein said registration processing section accepts device data of said Internet devices owned by said user, and said data storage section stores said device data by associating with said personal data.

13. The data management server according to claim 11, wherein said extraction processing section is controlled by an externally specified said condition.

14. The data management server according to claim 11, wherein said extraction processing section outputs said personal data of said user extracted based on said condition by excluding at least data identifying said user.

15. A home gateway system, comprising a home gateway that is connectable to an external network and to one or more devices via an internal network, and manages said devices, wherein personal data of a user who owns said home gateway and device data of said devices are registered with a server of an external administrator via said home gateway and said external network.

16. The home gateway system according to claim 15, wherein data communication between said home gateway and said devices is performed by means of wireless communication.

17. The home gateway system according to claim 15, wherein said home gateway is only responsible for a connection of said devices to said external network.

18. The home gateway system according to claim 15, wherein said user who owns said home gateway receives services based on said personal data and said device data registered in said server of said external administrator.
